(19) United States
(12) Patent Application Publication
(10) Pub. No.: US 2011/0063464 A1
(43) Pub. Date: Mar. 17, 2011

(54) VIDEO PLAYING SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/630,854

(22) Filed: Dec. 4, 2009

(30) Foreign Application Priority Data
Sep. 11, 2009 (CN) 200910306892.7

(51) Int. Cl. H04N 5/228; G06K 9/00

(52) U.S. Cl. 348/222.1; 382/103; 348/E05.031

(57) ABSTRACT

A video playing system includes a camera to capture images, a display unit, a processing unit, and a storage system. The storage system stores an animation which includes a controllable element. The processing unit detects an image from the camera, to identify an object in the image, and to obtain information about the object. The processing unit further receives the coordinates of the object in the image from the detecting module to obtain a position of a viewer related to the display unit, outputs one of a number of control instructions according to the position of the viewer to control movement of the element of the animation.

### BACKGROUND

1. Technical Field

The present disclosure relates to a video playing system and a video playing method.

2. Description of Related Art

Conventional video players cannot customize the display of video in response to different visual angles. Many commonly used video players are non-interactive, thereby reducing the level of user satisfaction.

### BRIEF DESCRIPTION OF THE DRAWINGS

FIG. 1 is a schematic block diagram of an exemplary embodiment of a video playing system including a storage system and a display unit.

FIG. 2 is a schematic block diagram of the storage system of FIG. 1.

FIGS. 3A-3C are schematic diagrams of the display unit displaying in three using states.

FIG. 4 is a flowchart of an exemplary embodiment of a video playing method.

### DETAILED DESCRIPTION

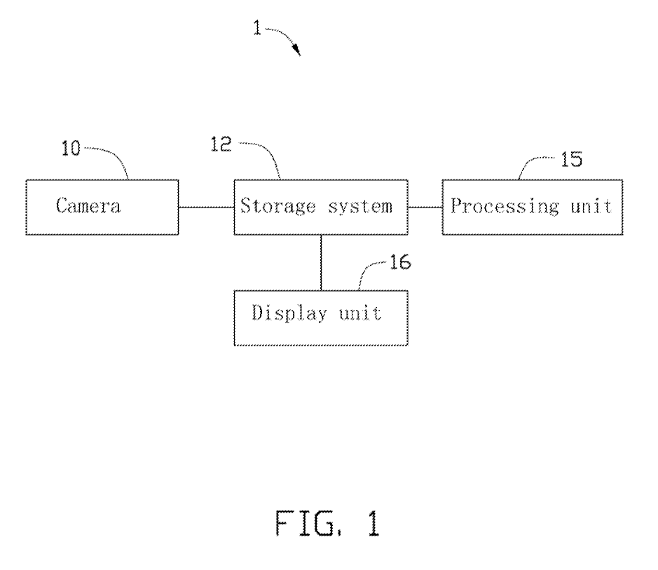

Referring to FIG. 1, a first embodiment of a video playing system 1 includes a camera 10, a storage system 12, a processing unit 15, and a display unit 16. The video playing system 1 is operable to play different videos according to different positions of a viewer.

The camera 10 is mounted on the display unit 16 and captures sequential images of the viewer.

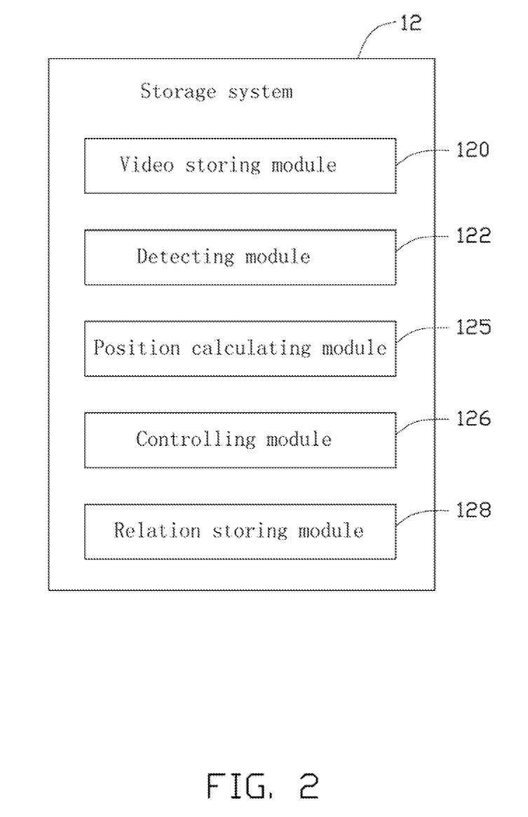

Referring to FIG. 2, the storage system 12 includes a video storing module 120, a detecting module 122, a position calculating module 125, a controlling module 126, and a relation storing module 128. The detecting module 122, the position calculating module 125, and the controlling module 126 may include one or more computerized instructions and are executed by the processing unit 15.

The video storing module 120 stores an animation which includes a controllable element. The element in the animation can be controlled by instructions. It can be understood that the animation can be made by Adobe Flash software. For example, a player can control a car to move in a flash game.

The detecting module 122 detects an image from the camera 10, to identify an object in the image, and to obtain information about the object. In the embodiment, the detecting module 122 is a face detecting module. The object is a face of the viewer. The detecting module 122 looks for the face in the image, and obtains information about the face. It can be understood that the face detecting module uses well known facial recognition technology to identify the face in the image. The information about the face may include coordinates of the found face in the image.

The position calculating module 125 receives the coordinates of the face in the image from the detecting module 122, to obtain a position of the viewer relative to the display unit 16. It can be understood that the position of the viewer is obtained via an angle between a line from a center of the face to a center of the display unit 16 and a reference line, such as a gravity line.

The relation storing module 128 stores a plurality of relations between a plurality of positions and a plurality of control instructions. Each position of the viewer corresponds to a control instruction. The plurality of control instructions is configured to control movement of the element in the animation.

The controlling module 126 outputs one of the plurality of control instructions according to the position of the viewer from the position calculating module 125 and the relation storing module 128. The control instruction is to control the element in the animation.

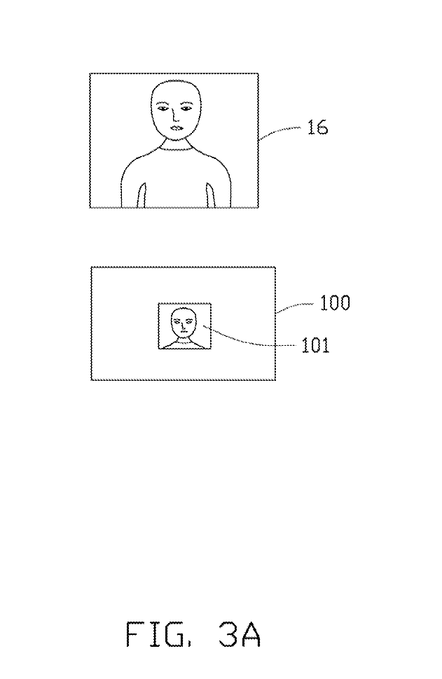

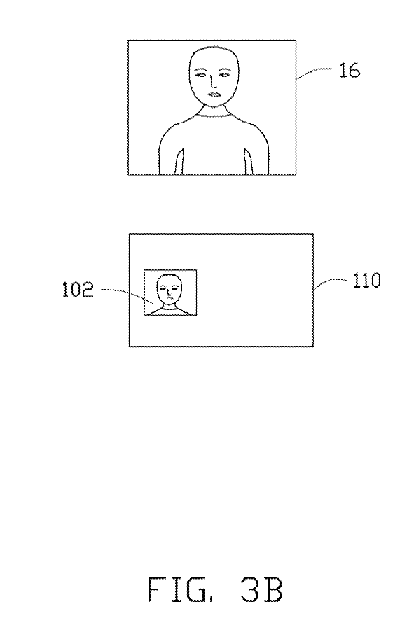

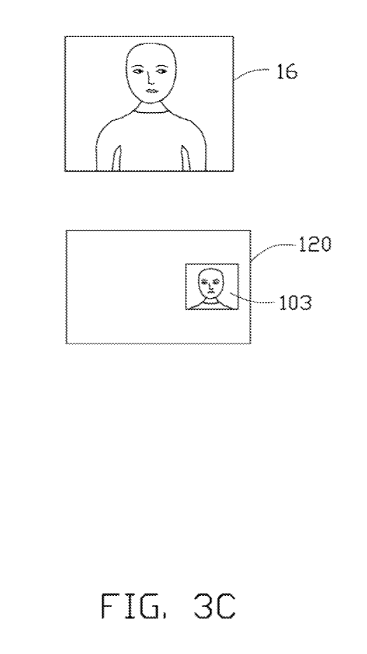

Referring to FIGS. 3A-3C, in this embodiment, the element in the animation are two eyeballs of a human figure. The two eyeballs can be controlled to move by the control instructions.

In FIG. 3A, the camera 10 captures a first sequential image 100. The detecting module 122 detects the first image 100 to identify a face 101, and to obtain information about the face 101. Supposing that a coordinate of a center of the display unit 16 is (0, 0), a coordinate of a center of the face 101 is (0, 0). As a result, the position calculating module 125 obtains the position of the viewer as a first position. The controlling module 126 outputs a first control instruction according to the relations stored in the relation storing module 128. The first control instruction controls the two eyeballs of the human in the animation to stand at the middle of eyes of the human on the display unit 16.

In FIG. 3B, the camera 10 captures a second sequential image 110. The detecting module 122 scans the second image 110 to identify a face 102, and to obtain information about the face 102. Supposing that a coordinate of the center of the display unit 16 is (0, 0), a coordinate of the center of the face 101 is (−1, 0). As a result, the position calculating module 125 obtains the position of the viewer is a second position. The controlling module 126 outputs a second control instruction according to the relations stored in the relation storing module 128. The second control instruction controls the two eyeballs of the human in the animation to move left.

In FIG. 3C, the camera 10 captures a third sequential image 120. The detecting module 122 scans the third image 120 to identify a face 103, and to obtain information about the face 103. Supposing that a coordinate of a center of the display unit 16 is (0, 0), a coordinate of a center of the face 101 is (1, 0). As a result, the position calculating module 125 obtains the position of the viewer is a third position. The controlling module 126 outputs a third control instruction according to the relations stored in the relation storing module 128. The third control instruction controls the two eyeballs of the human in the animation to move right.

As a result, the video playing system 1 can play different videos according to different positions of the viewer. In other embodiment, the element can be other portions, such as gestures. The video playing system 1 can control the human in the animation to perform different gestures according to different positions.

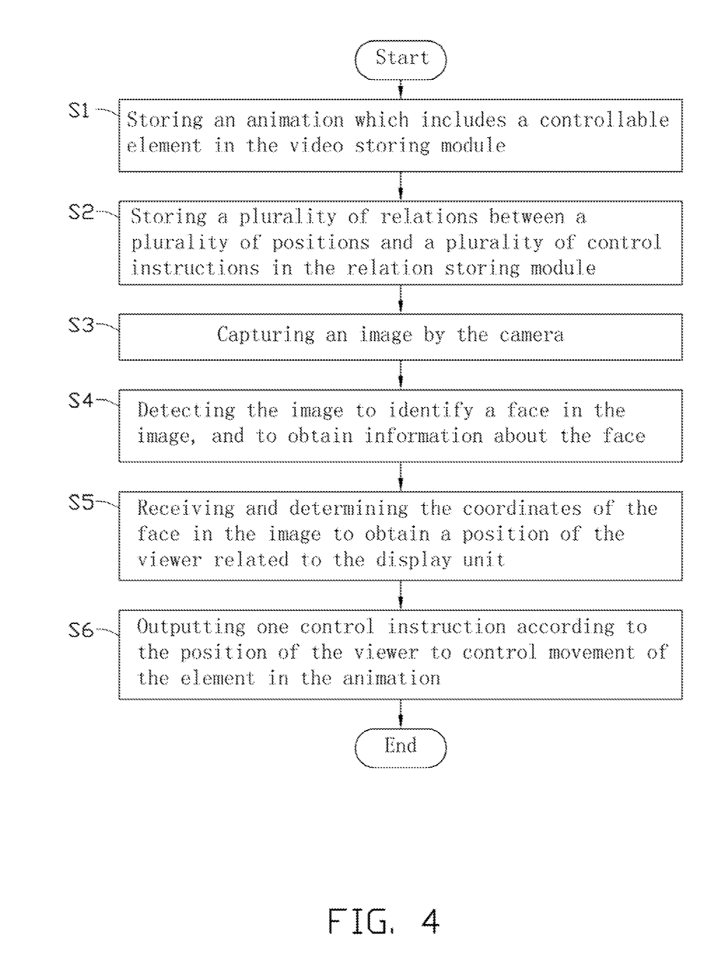

Referring to FIG. 4, an exemplary embodiment of a video playing method includes the following steps.

In step S1, an animation which includes a controllable element is stored in the video storing module 120. The element in the animation can be controlled by control instructions. It can be understood that the animation can be made by Adobe Flash software.

In step S2, a plurality of relations between a plurality of positions and a plurality of control instructions to control movement of the element in the animation are stored in the relation storing module 128. Each position of the viewer corresponds to a control instruction.

In step S3, the camera 10 captures an image.

In step S4, the detecting module 122 detects the image from the camera 10, to identify a face in the image, and to obtain information about the face. In the embodiment, the detecting module 120 is a face detecting module. It can be understood that the detecting module 120 uses well known facial recognition technology to identify the face in the image. The information about the face may include coordinates of the face in the image.

In step S5, the position calculating module 125 receives and determines the coordinates of the face in the image from the detecting module 122 to obtain a position of the viewer related to the display unit 16. It can be understood that it may obtain the position of the viewer via an angle between a line from a center of the face to a center of the display unit 16 and a reference line, such as a gravity line.

In step S6, the controlling module 126 outputs one of the plurality of control instructions according to the position of the viewer from the position calculating module 125 and the relation storing module 128 to control movement of the element in the animation.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A video playing system comprising:
a camera to capture an image of a viewer;
a display unit;
a processing unit; and
a storage system connected to the processing unit and storing a plurality of modules to be executed by the processing unit, wherein the plurality of modules comprise:
a video storing module to store an animation which comprises a controllable element;
a detecting module to detect the image from the camera, to identify an object in the image, and to obtain information about the object;
a position calculating module to receive coordinates of the object in the image from the detecting module, to obtain a position of the viewer related to the display unit;
a relation storing module to store a plurality of relations between a plurality of positions and a plurality of control instructions; and
a controlling module to output one of the plurality of control instructions according to the position of the viewer from the position calculating module and the relation storing module, to control movement of the controllable element of the animation.

2. The video playing system of claim 1, wherein the position of the viewer is an angle between a line from a center of the key portion to a center of the display unit and a reference line.

3. The video playing system of claim 2, wherein the reference line is a gravity line.

4. The video playing system of claim 1, wherein the element in the animation is two eyeballs of a person.

5. A video playing method comprising:
capturing an image of a viewer;
detecting the image to identify an object in the image, and to obtain information about the object;
receiving coordinates of the object in the image to obtain a position of the viewer related to a display unit; and
outputting one of a plurality of control instructions according to the position of the viewer and a plurality of relations between a plurality of positions and a plurality of control instructions, to control movement of an element in an animation.

6. The video playing method of claim 5, before capturing the image, further comprising:
storing the animation in a storage system; and
storing the plurality of relations between the plurality of positions and the plurality of control instructions in the storage system.

7. The video playing method of claim 5, wherein the position of the viewer is an angle between a line from a center of the key portion to a center of the display unit and a reference line.

8. The video playing method of claim 7, wherein the reference line is a gravity line.

9. The video playing method of claim 5, wherein the element in the animation is two eyeballs of a human.
